(19) United States
(12) Patent Application Publication
(10) Pub. No.: US 2022/0012724 A1
(43) Pub. Date: Jan. 13, 2022

(54) CURRENCY CONVERSION IN MEDIA CONTENT

(71) Applicant: International Business Machines Corporation, Armonk, NY (US)

(72) Inventors: Zachary A. Silverstein, Jacksonville, FL (US); Jacob Ryan Jepperson, Rochester, MN (US); Mustafa Alloh, Umm Al Quwain (AE); Jayanth Krishnan, Mahopac, NY (US)

(21) Appl. No.: 16/925,473

(22) Filed: Jul. 10, 2020

(51) Int. Cl. G06Q 20/38; G06Q 20/06

(52) U.S. Cl. CPC G06Q 20/381; G06Q 20/0652

(57) ABSTRACT

A piece of media is received. One or more preferences of a user is determined. Whether currency is captured in the piece of media is determined. Responsive to determining currency is captured in the piece of media, the currency is converted to an updated currency. The updated currency is provided to the user.

### BACKGROUND

The present invention relates generally to the field of media, and more particularly to converting currency in media to the preferences of the user.

Currency is a system of money in common use, especially for people in a nation or region. Generally, a specific currency is used within one nation or region and when traveling to a new or different nation or region, a person much use a second currency. Based on financial exchange rates, currency can be converted to and from one currency and another. Currency can be used to purchase items or services.

### SUMMARY

Embodiments of the present invention include a method, computer program product, and system for currency conversion. In an embodiment, a piece of media is received. One or more preferences of a user is determined. Whether currency is captured in the piece of media is determined. Responsive to determining currency is captured in the piece of media, the currency is converted to an updated currency. The updated currency is provided to the user.

### BRIEF DESCRIPTION OF THE DRAWINGS

FIG. 1 is a functional block diagram of a network computing environment, generally designated 100, suitable for operation of currency program 112, in accordance with at least one embodiment of the invention.

FIG. 2 is a flow chart diagram depicting operational steps for currency program 112 for currency conversion, in accordance with at least one embodiment of the invention.

FIG. 3 is an example media, in accordance with at least one embodiment of the invention.

FIG. 4 is a block diagram depicting components of a computer, generally designated 400, suitable for executing currency program 112, in accordance with at least one embodiment of the invention.

### DETAILED DESCRIPTION

Currency conversion occurs when a currency is transformed from a first currency to a second currency and/or when currency is converted from a first time to a second time. Disclosed herein is a method, computer program product and system of processing media content that include currency and automatically analyzing the media to convert mentions of currency from a first form to a second form.

Embodiments of the present invention recognize that users consume media on a regular basis. Embodiments of the present invention recognize that media may be in either a different location, time, or both than the consumer of the media is living. For example, a video may be filmed in France but a user from the United States may view the media. In another example, a video may be filmed in 2010 and a person may view it in 2020. Embodiments of the present invention recognize that currency can change value over location and/or time.

Embodiments of the present invention provide at least for receiving a piece of media and determining whether the media includes currency. Embodiments of the present invention provide at least for converting the currency from a first currency to a second currency and/or time based on user preferences. Embodiments of the present invention provide at least for providing the converted currency and additionally supplemental data.

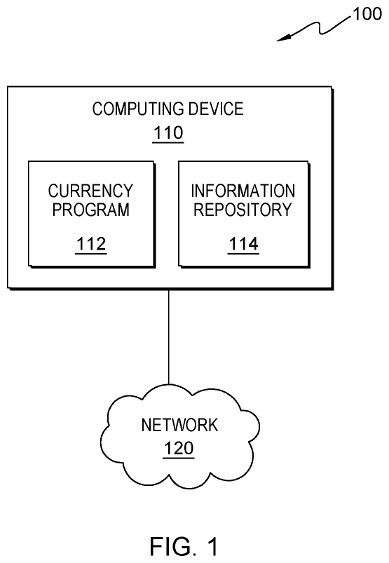

Referring now to various embodiments of the invention in more detail, FIG. 1 is a functional block diagram of a network computing environment, generally designated 100, suitable for operation of currency program 112 in accordance with at least one embodiment of the invention. FIG. 1 provides only an illustration of one implementation and does not imply any limitation with regard to the environments in which different embodiments may be implemented. Many modifications to the depicted environment may be made by those skilled in the art without departing from the scope of the invention as recited by the claims.

Network computing environment 100 includes computing device 110 interconnected over network 120. In embodiments of the present invention, network 120 can be a telecommunications network, a local area network (LAN), a wide area network (WAN), such as the Internet, or a combination of the three, and can include wired, wireless, or fiber optic connections. Network 120 may include one or more wired and/or wireless networks that are capable of receiving and transmitting data, voice, and/or video signals, including multimedia signals that include voice, data, and video formation. In general, network 120 may be any combination of connections and protocols that will support communications between computing device 110 and other computing devices (not shown) within network computing environment 100.

Computing device 110 is a computing device that can be a laptop computer, tablet computer, netbook computer, personal computer (PC), a desktop computer, a personal digital assistant (PDA), a smartphone, smartwatch, or any programmable electronic device capable of receiving, sending, and processing data. In general, computing device 110 represents any programmable electronic devices or combination of programmable electronic devices capable of executing machine readable program instructions and communicating with other computing devices (not shown) within computing environment 100 via a network, such as network 120.

In various embodiments of the invention, computing device 110 may be a computing device that can be a standalone device, a management server, a web server, a media server, a mobile computing device, or any other programmable electronic device or computing system capable of receiving, sending, and processing data. In other embodiments, computing device 110 represents a server computing system utilizing multiple computers as a server system, such as in a cloud computing environment. In an embodiment, computing device 110 represents a computing system utilizing clustered computers and components (e.g. database server computers, application server computers, web servers, and media servers) that act as a single pool of seamless resources when accessed within network computing environment 100.

In various embodiments of the invention, computing device 110 includes currency program 112 and information repository 114.

In an embodiment, computing device 110 includes a user interface (not shown). A user interface is a program that provides an interface between a user and an application. A user interface refers to the information (such as graphic, text, and sound) a program presents to a user and the control sequences the user employs to control the program. There are many types of user interfaces. In one embodiment, a user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements.

In an embodiment, computing device 110 includes currency program 112. Embodiments of the present invention provide for a currency program 112 that determines a user. In embodiments of the present invention, currency program 112 determines preferences of the user. In embodiments of the present invention, currency program 112 receives media. In embodiments of the present invention, currency program 112 processes the media. In embodiments of the present invention, currency program 112 determines if currency is captured. In embodiments of the present invention, currency program 112 converts the currency. In embodiments of the present invention, currency program 112 provides the converted currency to the user. In embodiments of the present invention, currency program 112 provides supplemental information to the user. In an embodiment, currency program 112 may be found on another computing device (not shown), and a user, via the user interface of computing device 110 may interact with currency program 112 via network 120.

In an embodiment, computing device 110 includes information repository 114. In an embodiment, information repository 114 may be managed by currency program 112. In an alternative embodiment, information repository 114 may be managed by the operating system of computing device 110, another program (not shown), alone, or together with, currency program 112. Information repository 114 is a data repository that can store, gather, and/or analyze information. In some embodiments, information repository 114 is located externally to computing device 110 and accessed through a communication network, such as network 120. In some embodiments, information repository 114 is stored on computing device 110. In some embodiments, information repository 114 may reside on another computing device (not shown), provided information repository 114 is accessible by computing device 110. Information repository 114 may include, but is not limited to, user preferences, currency conversion data, historical elasticity of demand data, regional commerce platform data, etc.

Information repository 114 may be implemented using any volatile or non-volatile storage media for storing information, as known in the art. For example, information repository 114 may be implemented with a tape library, optical library, one or more independent hard disk drives, multiple hard disk drives in a redundant array of independent disks (RAID), solid-state drives (SSD), or random-access memory (RAM). Similarly, information repository 114 may be implemented with any suitable storage architecture known in the art, such as a relational database, an object-oriented database, or one or more tables.

As referred to herein, all data retrieved, collected, and used, is used in an opt-in manner, i.e., the data provider has given permission for the data to be used. For example, the received data received and used by currency program 112 for currency conversion.

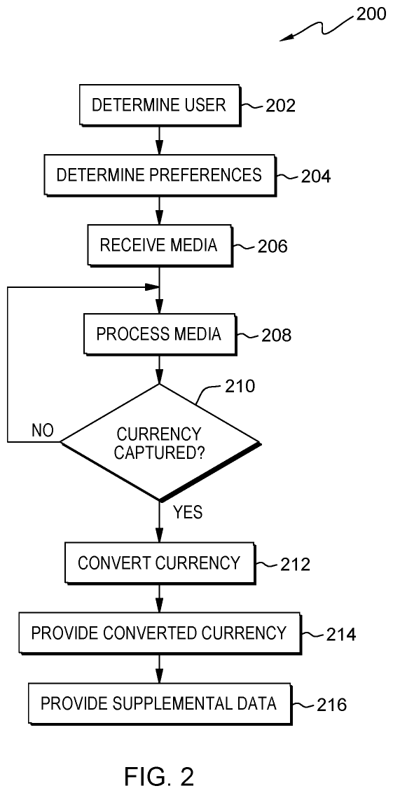

FIG. 2 is a flow chart diagram of workflow 200 depicting operational steps for currency program 112 in accordance with at least one embodiment of the invention. In an alternative embodiment, the steps of workflow 200 may be performed by any other program while working with currency program 112. It should be appreciated that embodiments of the present invention provide at least for currency conversion. However, FIG. 2 provides only an illustration of one implementation and does not imply any limitations with regard to the environments in which different embodiments may be implemented. Many modifications to the depicted environment may be made by those skilled in the art without departing from the scope of the invention as recited by the claims. In a preferred embodiment, a user, via a user interface (not shown), can invoke workflow 200 upon a user wanting currency program 112 to convert currency found in media.

Currency program 112 determines a user (step 202). At step 202, currency program 112 receives an indication that a user would like a piece of media content to be analyzed by currency program 112. In an embodiment, the user may login directly to currency program 112 and currency program 112 confirms login credentials using data stored in information repository 114. In an alternative embodiment, the user may login to another program (e.g., a streaming service not shown) and the other program indicates to currency program 112 the user that wishes to use currency program 112.

Currency program 112 determines user preferences (step 204). At step 204, currency program 112 determines the user preferences for the user of step 202, including, but not limited to, one or more preferred languages, one or more preferred currencies, one or more preferred commerce platforms, etc. In an embodiment, currency program 112 determines if the user preferences are stored in information repository 114. In an embodiment, currency program 112 may determine there are no user preferences or only partial user preferences in information repository 114, and currency program 112 will query the user for the user preferences via the user interface (not shown). In an embodiment, the user preferences may indicate that currency program 112 should adjust the preferred language, preferred currency, and/or preferred commerce platform based on the location of the user when they are viewing the media. In an embodiment, if more than one preferred language, more than one preferred currency, and/or more than one preferred commerce plan is indicated, currency program 112 may query the user for a single preferred language, single preferred currency, and/or single preferred commerce platform.

Currency program 112 receives media (step 206). At step 206, currency program 112, receives an indication of one or more pieces of media to analyze. In an embodiment, media includes, but is not limited to, video, pictures, presentations, etc. In an embodiment, currency program 112 may receive the media directly. For example, a video may be uploaded to information repository 114 for analysis by currency program 112. In an alternative embodiment, currency program 112 may receive information about the media, for example a hyperlink, and currency program 112 will use the hyperlink to view, receive, and/or analyze the media. In yet another embodiment, currency program 112 may be integrated with another program (e.g., a web browser), and currency program 112 may analyze any media that is viewed within the other program.

Currency program 112 processes the received media (step 208). At step 208, currency program 112 can process the received media using any process known in the art, including but not limited to, image processing, video processing, and/or audio processing. In an embodiment, image processing includes, but is not limited to, capturing the currency, such as bills and/or coins, shown in an image, capturing the currency listed in comments of the video such as a dollar amount, capture the price listed in an image via optical character recognition (OCR) technologies, capture geolocational tag of image and related images/trips on the platform or in the image exif metadata, or capture subject line/header locational indicators. In an embodiment, video/audio processing includes, but is not limited to, capture the currency shown in a video using OCR, capture the currency spoken about in a video, capture prices listen and currency indicators (e.g., $, €, etc.), capture monetary amounts via natural language processing (NLP) to determine context of currency being mentioned, and/or utilize the translation of the video/audio subtitles to determine currency indicators.

Currency program 112 determines whether currency is captured (decision step 210). At step 210, currency program 112 uses the information determined during the media processing of step 208 to determine whether currency is captured. In an embodiment, currency program 112 may use bag of words model that does algorithm topic processing to determine if currency is mentioned and the country or countries associated with the currency is being mentioned. In an embodiment, currency program 112 may use ontology of words related to commerce to determine if currency is being mentioned. In yet another embodiment, currency program 112 may determine currency is being mentioned when a number and a currency indicator, such a character that represents currency, (e.g., $, €, etc.) are mentioned together. If currency is captured (decision step 210, yes branch) processing proceeds to step 212. If currency is not captured (decision step 210, no branch) processing proceeds to step 212 and the remaining media or a new piece of media are processed.

Currency program 112 converts the currency (step 212). At step 212, currency program 112 converts the currency used in the media to a new currency value based on the user preferences. In an embodiment, currency program 112 may convert the currency from a value in a first currency found in the media to a value in a second currency, where the second currency is based on the user preferences. In an embodiment, currency program 112 may convert the currency from the value in the first currency to the value in the second currency based on real-time conversion rates found on other data sources (e.g. banking websites, financial websites, etc.). In an alternative embodiment, currency program 112 may convert the currency from the value in the first currency to the value in the second currency based on a data source indicated by the user (e.g., a specific website, etc.). In an embodiment, currency program 112 may convert the currency from a value at a first time found in the media to a value at a second time (e.g., current time, etc.). In an embodiment, currency program 112 may convert the currency from a value at a first time to a value at a second time based on conversion rates found on other data sources (e.g. banking websites, financial websites, etc.). In an alternative embodiment, currency program 112 may convert the currency from a value at a first time to a value at a second time based on a data source indicated by the user (e.g., a specific website, etc.). In an embodiment, currency program 112 may convert the currency from a first language to a second language. In an embodiment, currency program 112 may do any combination of the above-referenced conversions found in step 212. In an embodiment, currency program 112 may make the above-referenced conversions found in step 212 using data found in information repository 114. In an alternative embodiment, currency program 112 may make the above-reference conversions found in step 212 while interacting with other programs (not shown). In an embodiment, currency can be converted using a standard market basket translation.

Currency program 112 provides the converted currency (step 214). At step 214, currency program 112 provides the converted currency in the user interface (not shown) of computing device 110. In an embodiment, currency program 112 may provide the converted currency within the received media. In other words, currency program 112 may provide the converted currency for integration into the media. For example, the converted currency may be provided in a similar form to subtitles as a box on a part of the video. In an alternative embodiment, currency program 112 may edit already existing subtitles found in the media to include the converted currency. In yet another alternative embodiment, currency program 112 may provide a standalone notification that shows up in graphical display of currency program 112 or a graphical display on display of computing device 110.

Currency program 112 provides supplemental data (step 216). At step 216, currency program 112 may provide additional information to the provided converted currency. As discussed in step 216, currency program 112 may provide the additional information within the received media or as a standalone notification. In an embodiment, the additional information includes, but is not limited to, conversion rates used to calculate from a first currency to a second currency, conversion rates used to calculate from a first data to a second date, regional commerce platforms, based on user preferences, for purchasing one or more items, and/or historical elasticity of demand of the price of the item for use by the user.

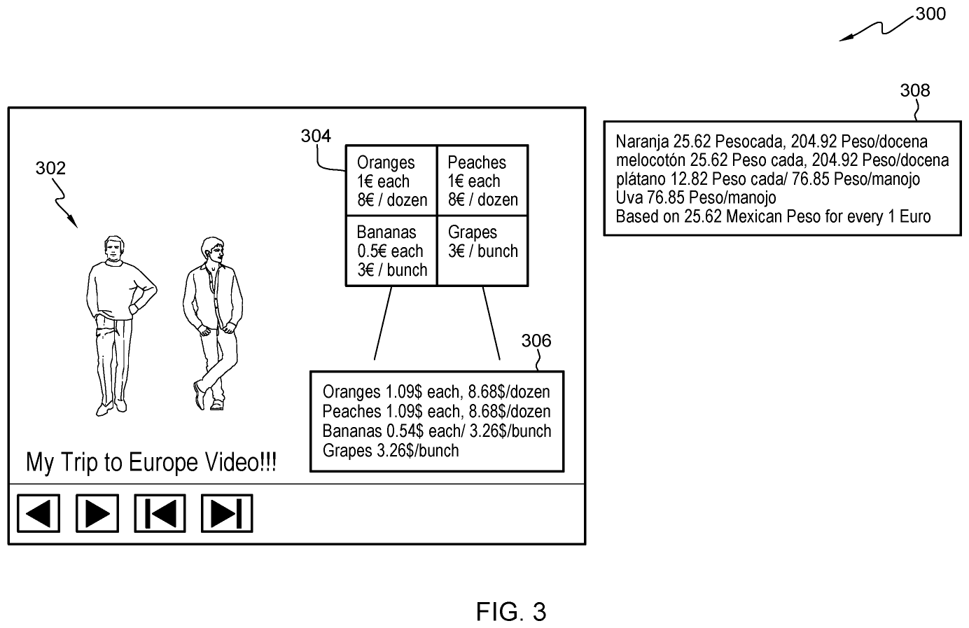

FIG. 3 is an example media 300 depicting currency and converted currency, in accordance with at least one embodiment of the invention. FIG. 3 is a piece of media 300 that includes a user 302 interacting in an environment. In this example, this is a piece of media 300 titled “My Trip to Europe Video!!!”. In this example, the media 300 has a sign 304 that states prices for items. For example, oranges cost 1€ each and 8€ a dozen, peaches cost 1€ and 8€ a dozen, bananas cost 0.5€ each and 3€ a bunch, and grapes cost 3€ a bunch. In this example, currency program 112 has analyzed this piece of media 400 and provided the converted currency in two forms. In the example, the converted currency is found imbedded within the media 300 as indicated by 306. Additionally, in this example, the converted currency is found in a separate standalone display in the user interface as indicated by 308. It should be noted, that generally only one of these converted currencies is displayed, based on user preference.

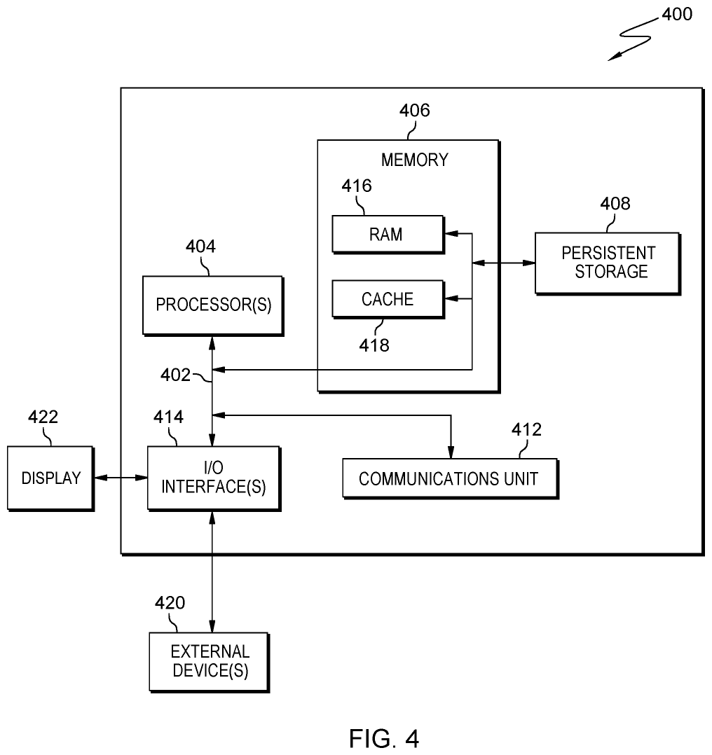

FIG. 4 is a block diagram depicting components of a computer 400 suitable for currency program 112, in accordance with at least one embodiment of the invention. FIG. 4 displays the computer 400, one or more processor(s) 404 (including one or more computer processors), a communications fabric 402, a memory 406 including, a RAM 416, and a cache 418, a persistent storage 408, a communications unit 412, I/O interfaces 414, a display 422, and external devices 420. It should be appreciated that FIG. 4 provides only an illustration of one embodiment and does not imply any limitations with regard to the environments in which different embodiments may be implemented. Many modifications to the depicted environment may be made.

As depicted, the computer 400 operates over the communications fabric 402, which provides communications between the computer processor(s) 404, memory 406, persistent storage 408, communications unit 412, and input/output (I/O) interface(s) 414. The communications fabric 402 may be implemented with an architecture suitable for passing data or control information between the processors 404 (e.g., microprocessors, communications processors, and network processors), the memory 406, the external devices 420, and any other hardware components within a system. For example, the communications fabric 402 may be implemented with one or more buses.

The memory 406 and persistent storage 408 are computer readable storage media. In the depicted embodiment, the memory 406 comprises a random-access memory (RAM) 416 and a cache 418. In general, the memory 406 may comprise any suitable volatile or non-volatile one or more computer readable storage media.

Program instructions for currency program 112 may be stored in the persistent storage 408, or more generally, any computer readable storage media, for execution by one or more of the respective computer processors 404 via one or more memories of the memory 406. The persistent storage 408 may be a magnetic hard disk drive, a solid-state disk drive, a semiconductor storage device, read only memory (ROM), electronically erasable programmable read-only memory (EEPROM), flash memory, or any other computer readable storage media that is capable of storing program instruction or digital information.

The media used by the persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of the persistent storage 408.

The communications unit 412, in these examples, provides for communications with other data processing systems or devices. In these examples, the communications unit 412 may comprise one or more network interface cards. The communications unit 412 may provide communications through the use of either or both physical and wireless communications links. In the context of some embodiments of the present invention, the source of the various input data may be physically remote to the computer 400 such that the input data may be received, and the output similarly transmitted via the communications unit 412.

The I/O interface(s) 414 allow for input and output of data with other devices that may operate in conjunction with the computer 400. For example, the I/O interface 414 may provide a connection to the external devices 420, which may be as a keyboard, keypad, a touch screen, or other suitable input devices. External devices 420 may also include portable computer readable storage media, for example thumb drives, portable optical or magnetic disks, and memory cards. Software and data used to practice embodiments of the present invention may be stored on such portable computer readable storage media and may be loaded onto the persistent storage 408 via the I/O interface(s) 414. The I/O interface(s) 414 may similarly connect to a display 422. The display 422 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adaptor card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, though the Internet using an Internet Service Provider). In some embodiments, electronic circuitry including, for example programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram blocks or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of computer program instructions, which comprises one or more executable instructions for implementing the specified logical function(s). In some alternative implementations, the functions noted in the block may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing form the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for currency conversion, the computer-implemented method comprising the steps of:
receiving, by one or more computer processors, a piece of media, wherein the media is a video;
determining, by one or more computer processors, one or more preferences of a user;
determining, by one or more computer processors, whether currency is captured in the piece of media using audio and video processing, wherein the audio and video processing is selected from the group consisting of optical character recognition, natural language processing, and translation of video/audio subtitles;
determining, by one or more computer processors, a first time of the media, wherein the first time is a time the media was recorded;
determining, by one or more computer processors, a second time, wherein the second time is a current time;
responsive to determining currency is captured in the piece of media, converting, by one or more computer processors, a value of the currency at the first time to an updated value of the currency at the second time; and
providing, by one or more computer processors, the updated value of the currency to the user.

2. The computer-implemented method of claim 1, wherein the user preferences are selected from the group consisting of one or more preferred languages, one or more preferred currencies, and one or more preferred commerce platforms.

3. The computer-implemented method of claim 1, wherein determining, by one or more computer processors, whether currency is captured in the piece of media comprises:
analyzing, by one or more computer processors, the piece of media, wherein analyzing is selected from the group consisting of, image processing, video processing, and audio processing;
determining, by one or more computer processors, whether currency is captured if a number and currency indicator is found, wherein a currency indicator is a character that represents currency.

4. (canceled)

5. (canceled)

6. (canceled)

7. (canceled)

8. A computer program product for currency conversion, the computer program product comprising:
one or more computer readable storage media; and
program instructions stored on the one or more computer readable storage media, the program instructions comprising:
program instructions to receive a piece of media, wherein the media is a video;
program instructions to determine one or more preferences of a user;
program instructions to determine whether currency is captured in the piece of media using audio and video processing, wherein the audio and video processing is selected from the group consisting of optical character recognition, natural language processing, and translation of video/audio subtitles;
program instructions to determine a first time of the media, wherein the first time is a time the media was recorded;
program instructions to determine a second time, wherein he second time is a current time;
responsive to determining currency is captured in the piece of media, program instructions to convert a value of the currency at the first time to an updated value of the currency at the second time; and
program instructions to provide the updated currency to the user.

9. The computer program product of claim 8, wherein the user preferences are selected from the group consisting of one or more preferred languages, one or more preferred currencies, and one or more preferred commerce platforms.

10. The computer program product of claim 8, wherein the program instructions to determine whether currency is captured in the piece of media comprises:
program instructions to analyze the piece of media, wherein analyzing is selected from the group consisting of, image processing, video processing, and audio processing;
program instructions to determine whether currency is captured if a number and currency indicator is found, wherein a currency indicator is a character that represents currency.

11. (canceled)

12. (canceled)

13. (canceled)

14. (canceled)

15. A computer system for currency conversion, the computer system comprising:
one or more computer processors;
one or more computer readable storage media; and
program instructions stored on the one or more computer readable storage media for execution by at least one of the one or more computer processors, the program instructions comprising:
program instructions to receive a piece of media, wherein the media is a video;
program instructions to determine one or more preferences of a user;
program instructions to determine whether currency is captured in the piece of media using audio and video processing, wherein the audio and video processing is selected from the group consisting of optical character recognition, natural language processing, and translation of video/audio subtitles;
program instructions to determine a first time of the media, wherein the first time is a time the media was recorded;
program instructions to determine a second time, wherein he second time is a current time;
responsive to determining currency is captured in the piece of media, program instructions to convert a value of the currency at the first time to an updated value of the currency at the second time; and
program instructions to provide the updated currency to the user.

16. The computer system of claim 15, wherein the user preferences are selected from the group consisting of, one or more preferred languages, one or more preferred currencies, and one or more preferred commerce platforms.

17. The computer system of claim 15, wherein the program instructions to determine whether currency is captured in the piece of media comprises:
program instructions to analyze the piece of media, wherein analyzing is selected from the group consisting of image processing, video processing, and audio processing;
program instructions to determine whether currency is captured if a number and currency indicator is found, wherein a currency indicator is a character that represents currency.

18. (canceled)

19. (canceled)

20. (canceled)
